(19) United States
(12) Patent Application Publication
(10) Pub. No.: US 2002/0123150 A1
(43) Pub. Date: Sep. 5, 2002

(54) Method

(76) Inventors: Zeenat Nabi, Cranbury, NJ (US); Amir Tavakkol, Mountain Lakes, NJ (US); Thomas Gregory Polefka, Somerset, NJ (US)

Correspondence Address: COLGATE-PALMOLIVE COMPANY, 909 RIVER ROAD, PISCATAWAY, NJ, 08855, US

(21) Appl. No.: 09/745,671

(22) Filed: Dec. 21, 2000

(51) Int. Cl. G01N 31/22

(52) U.S. Cl. 436/94; 436/169

(57) ABSTRACT

A method for demonstrating the effectiveness of an antioxidant containing composition in neutralizing a free radical bearing entity which comprises:

(a) contacting said composition with a free radical bearing entity for a period of time to neutralize at least a portion of the free radical bearing entity thereby forming a second composition which has at least some neutralized free radical bearing entity,

(b) contacting at least a portion of the second composition with a system which is color sensitive to a free radical bearing entity for a sufficient time for any color change to develop, and

(c) evaluating the evolved change in color.

### BACKGROUND OF INVENTION

The washing of human skin with cleansing formulation or the treatment of skin with “leave on” compositions to provide certain effects such as moisturization has been known for many centuries. It is only relatively recently however that there have been serious attempts to bring a beneficial effect such as moisturization, for example, into an aqueous skin cleansing formulation. In the last few years, other benefits to skin have been identified, particularly those of antioxidants. Certain abnormal conditions and disease etiologies present in skin such as premature aging, inflammatory disorders, and photo-carcinogenesis due to UV induced formation of free radicals, for example, seem to be at least partially responsible for or at least have implicated in their progress the presence of free radical containing chemical entities. Such entities include peroxides, superoxide anion, H₂O₂, hydroxy radical, singlet oxygen, hypochlorite, alkyl radical (intermediate to lipid oxidation) and the like. The entity carrying the free radical can be a lipid. Antioxidants can control the generation and/or propagation of this free radical containing entities. Examples of these antioxidants include vitamins such as A, C, D, E, B1, B5 (panthenol), coenzyme Q10, K and the like, uric acid, glutathione, and the like. Examples of enzymatic systems include superoxide dismutase, catalase, glutathione peroxidase and reductases, dehydrogenases such as glucose 6 phosphate dehydrogenase and isocitrate dehydrogenase, and the like. Some of these materials, particularly certain vitamins, such as vitamin E (tocopherol) and derivatives thereof, such as esters, are known antioxidants or proantioxidants and are now being considered for incorporation into various skin care products, particularly those of the rinse off type, such as aqueous skin cleansing liquids and gels. These antioxidants can reduce the number of free radicals formed by various insults to the skin such as UV irradiation, air pollution, and cigarette smoke.

Up until this time, the general populace has had no visual means of rapidly evaluating the effectiveness of an antioxidant containing composition in neutralizing and/or reducing free radical activity.

A new test system has now been discovered which can accomplish this goal. It is rapid. It can visually demonstrate the efficacy of any such effective or purportedly effective composition, which neutralizes free radical activity.

### SUMMARY OF THE INVENTION

In accordance with the invention, there is a method for demonstrating the effectiveness of an antioxidant containing composition in neutralizing a free radical bearing entity, which comprises

(a) contacting said composition with a free radical entity for a period of time to neutralize at least a portion of the free radical bearing entity thereby forming a second composition which has at least some neutralized free radical bearing entity,

(b) contacting at least a portion of the second composition with a system which is color sensitive to a free radical bearing entity for a sufficient time for any color change to develop, and

(c) evaluating the evolved change in color.

Uses of the invention include the evaluation of the amount of free radical entities present after contact with antioxidant containing compositions of unknown quantity; or comparing a known to an unknown level of free radical entity through the color evaluation; preparing a standard curve produced by a known free radical based upon color and then measuring evolved color formation from an unknown level of free radical entity. All of these evaluations involve the contacting of a free radical bearing entity-containing composition with an antioxidant containing composition prior to evaluation of color change through the color sensitive system.

### DETAILED DESCRIPTION OF THE INVENTION

Free radical bearing entities, which are thought to be involved in bringing about, undesirable conditions or disease states include peroxides, superoxides, and those previously mentioned. These free radical bearing entities are implicated or thought to be implicated in the promulgation and/or maintenance of various conditions and skin disease states such as inflammatory conditions, premature aging, and cancer. Since they appear to act as an electron capturer through their elevated oxidation state, the use of antioxidants to neutralize the effect of these potential oxidizing agents, i.e., free radical bearing entities, by rendering them ineffective as powerful electron capturing agents, has become ever more popular. Such antioxidants include among those previously mentioned, particularly the vitamins, especially E and its precursors as aforementioned. Of these, a significant number are in everyday use and are essentially nontoxic in a composition which can be administered topically or systemically to a mammal, particularly a human.

This invention provides a method for assessing the effectiveness of such an antioxidant containing composition in neutralizing free radical bearing entities. It can be done in a fairly rapid manner, for example, in only a few minutes or even less, such as less than 60 or 30 seconds and evaluated visually by a human naked eye or through instrumentation.

By contacting the free radical bearing entity with a system which is color sensitive to the presence of the free radical a color evolves over time, the intensity of the color indicative of the amount of free radical bearing entity present in the composition. Examples of such color sensitive systems are methylene blue derivatives, for example 10-N-methylcarbamoyl-3, 7-dimethylamino-10 H-phenothiazine (MCDP) and the like catalyzed with a myoglobin or preferably a hemoglobin catalyst. Other systems include the thiobarbituric acid (TBA) both in colorimetry and spectrofluorophotometry assays at which seem to measure the by-product Malonaldehyde (MDA). The MCDP system is preferred together with the hemoglobin.

Through this invention a composition containing an antioxidant can provide a visually observable test system because of its ability to neutralize a free radical bearing entity.

Examples of compositions which can be evaluated in this manner are any antioxidant containing composition which can interact with a free radical bearing entity and which is compatible and reactive with the color sensitive sensing system. Examples of these general types of compositions include but are not limited to solid cleansing compositions for the body, hard surfaces, or fabric; liquid and gel cleansing compositions for the body, hard surface or fabric, liquid leave on compositions such as lotions, creams, and the like for purposes such as moisturizing, sun protection, enhancing elasticity, increasing skin immune system, nourishing, rejuvenating and reducing wrinkles of skin as well as oral compositions for cleansing the oral cavity, or teeth cleansing (paste, gel and the like).

With respect to cleansing compositions, a cleansing effective amount of a surfactant or mixture thereof is present. Surfactant(s), which can be employed, include anionic, nonionic, amphoteric and cationic. Any anionic surfactant can be employed. Examples of such anionic surfactants include soap, a long chain alkyl or alkenyl, branched or normal carboxylic acid salt such as sodium, potassium, ammonium or substituted ammonium salt, can be present in the composition. Exemplary of long chain alkyl or alkenyl are from about 8 to about 22 carbon atoms in length, specifically about 10 to about 20 carbon atoms in length, more specifically alkyl and most specifically normal, or normal with little branching. Small quantities of olefinic bond(s) may be present in the predominantly alkyl sections, particularly if the source of the “alkyl” group is obtained from a natural product such as tallow, coconut oil and the like. Anionic non-soap surfactants can be exemplified by the alkali metal salts of organic sulfate having in their molecular structure an alkyl radical containing from about 8 to about 22 carbon atoms and a sulfonic acid or sulfuric acid ester radical (included in the term alkyl is the alkyl portion of higher acyl radicals). Preferred are the sodium, ammonium, potassium or triethanolamine alkyl sulfates, especially those obtained by sulfating the higher alcohols (C₈-C₁₈ carbon atoms), sodium coconut oil fatty acid monoglyceride sulfates and sulfonates; sodium or potassium salts of sulfuric acid esters of the reaction product of 1 mole of a higher fatty alcohol (e.g., tallow or coconut oil alcohols) and 1 to 12 moles of ethylene oxide; sodium or potassium salts of alkyl phenol ethylene oxide ether sulfate with 1 to 10 units of ethylene oxide per molecule and in which the alkyl radicals contain from 8 to 12 carbon atoms, sodium alkyl glyceryl ether sulfonates; the reaction product of fatty acids having from 10 to 22 carbon atoms esterified with isethionic acid and neutralized with sodium hydroxide; water soluble salts of condensation products of fatty acids with sarcosine; and others known in the art for example taurates, phosphate, and those listed in the McCutcheon's Encyclopedia of Surfactants.

Other surfactants may be present in the composition. Examples of these surfactants include zwitterionic surfactants can be exemplified by those which can be broadly described as derivatives of aliphatic quaternary ammonium, phosphonium, and sulfonium compounds, in which the aliphatic radicals can be straight chain or branched and wherein one of the aliphatic substituents contains from about 8 to 18 carbon atoms and one contains an anionic water-solubilizing group, e.g., carboxy, sulfonate, sulfate, phosphate, or phosphonate. A general formula for these compounds is:

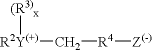

wherein R² contains an alkyl, alkenyl, or hydroxy alkyl radical of from about 8 to about 18 carbon atoms, from 0 to about 10 ethylene oxide moieties and from 0 to 1 glyceryl moiety; Y is selected from the group consisting of nitrogen, phosphorus, and sulfur atoms; R³ is an alkyl or monohydroxyalkyl group containing 1 to about 3 carbon atoms; X is 1 when Y is a sulfur atom and 2 when Y is a nitrogen or phosphorus atom, R⁴ is an alkylene or hydroxyalkylene of from 0 to about 4 carbon atoms and Z is a radical selected from the group consisting of carboxylate, sulfonate, sulfate, phosphonate, and phosphate groups.

Examples include: 4-[N, N-di (2-hydroxyethyl)-N-octadecyl-ammonio]-butane-1-carboxylate; 5-[S-3-hydroxypropyl-S-hexadecyl-sulfonio]-3 hydroxy-pentane-1-sulfate; 3-[P, P-P-diethyl-P 3,6,9 trioxatetradecyl-phosphonio]-2-hydroxypropane-1-phosphate; 3-[N, N-di-propyl-N-3 dodecoxy-2-hydroxy-propylammonio]-propane-1-phosphonate; 3-(N, N-di-methyl-N-hexadecyl-ammonio) propane-1-sulfonate; 3-(N, N-di-methyl-N-hexadecylammonio)-2-hydroxypropane-1-sulfonate; 4-(N, N-di (2-hydroxyethyl)-N-(2 hydroxydodecyl) ammonio]-butane-1-carboxylate; 3-[S-ethyl-S-(3-dodecoxy-2-hydroxy-propyl)sulfonio]-propane-1-phosphate; 3-(P,P-dimethyl-P-dodecylphosphonio)-propane-1-phosphonate; and 5-[N,N-di(3-hydroxypropyl)-N-hexadecyl-ammonio]-2-hydroxy-pentane-1-sulfate.

Examples of amphoteric surfactants which can be used in the compositions of the present invention are those which can be broadly described as derivatives of aliphatic secondary and tertiary amines in which the aliphatic radical can be straight chain or branched and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecylaminopropionate, sodium 3-dodecylaminopropane sulfonate, N-alkyltaurines, such as the one prepared by reacting dodecylamine with sodium isethionate according to the teaching of U.S. Pat. No. 2,658,072, N-higher alkyl aspartic acids, such as those produced according to the teaching of U.S. Pat. No. 2,438,091 and the products sold under the trade name “Miranol” and described in U.S. Pat. No. 2,528,378. Other amphoterics such as betaines are also useful in the present composition.

Examples of betaines useful herein include the high alkyl betaines such as cocodimethyl carboxymethyl betaine, lauryl dimethyl carboxy-methyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl) carboxymethyl betaine, oleyl dimethyl gamma-carboxypropyl betaine, lauryl bis-(2-hydro-xypropyl) alpha-carboxyethyl betaine, etc. The sulfobetaines may be represented by cocodimethyl sulfopropyl betaine, stearyl dimethyl sulfopropyl betaine, amido betaines, amidosulfobetaines, and the like.

Many cationic surfactants are known to the art. By way of example, the following may be mentioned:

stearyldimethylbenzyl ammonium chloride;

dodecyltrimethylammonium chloride;

nonylbenzylethyldimethyl ammonium nitrate;

tetradecylpyridinium bromide;

laurylpyridinium chloride;

cetylpyridinium chloride

laurylpyridinium chloride;

laurylisoquinolium bromide;

ditallow(hydrogenated)dimethyl ammonium chloride;

dilauryldimethyl ammonium chloride; and

stearalkonium chloride.

Additional cationic surfactants are disclosed in U.S. Pat. No. 4,303,543. See column 4, lines 58 and column 5, lines 1-42, incorporated herein by references. Also see CTFA Cosmetic Ingredient Dictionary, 4th Edition 1991, pages 509-514 for various long chain alkyl cationic surfactants; incorporated herein by references.

Nonionic surfactants can be broadly defined as compounds produced by the condensation of alkylene oxide groups (hydrophilic in nature) with an organic hydrophobic compound, which may be aliphatic or alkyl aromatic in nature. Examples of preferred classes of nonionic surfactants are:

1. The polyethylene oxide condensates of alkyl phenols, e.g., the condensation products of alkyl phenols having an alkyl group containing from about 6 to 12 carbon atoms in either a straight chain or branched chain configuration, with ethylene oxide, the said ethylene oxide being present in amounts equal to 10 to 60 moles of ethylene oxide per mole of alkyl phenol. The alkyl substituent in such compounds may be derived from polymerized propylene, diisobutylene, octane, or nonane, for example.

2. Those derived from the condensation of ethylene oxide with the product resulting from the reaction of propylene oxide and ethylene diamine products which may be varied in composition depending upon the balance between the hydrophobic and hydrophilic elements which is desired. For example, compounds containing from about 40% to about 80% polyoxyethylene by weight and having a molecular weight of from about 5,000 to about 11,000 resulting from the reaction of ethylene oxide groups with a hydrophobic base constituted of the reaction product of ethylene diamine and excess propylene oxide, said base having a molecular weight of the order of 2,500 to 3,000, are satisfactory.

3. The condensation product of aliphatic alcohols having from 8 to 18 carbon atoms, in either straight chain or branched chain configuration with ethylene oxide, e.g., a coconut alcohol ethylene oxide condensate having from 10 to 30 moles of ethylene oxide per mole of coconut alcohol, the coconut alcohol fraction having from 10 to 14 carbon atoms. Other ethylene oxide condensation products are ethoxylated fatty acid esters of polyhydric alcohols (e.g., Tween 20-polyoxyethylene (20) sorbitan monolaurate).

4. Long chain tertiary amine oxides corresponding to the following general formula:

R₁R₂R₃N→O

wherein R₁ contains an alkyl, alkenyl or monohydroxy alkyl radical of from about 8 to about 18 carbon atoms, from 0 to about 10 ethylene oxide moieties, and from 0 to 1 glyceryl moiety, and, R₂ and R₃ contain from 1 to about 3 carbon atoms and from 0 to about 1 hydroxy group, e.g., methyl, ethyl, propyl, hydroxy ethyl, or hydroxy propyl radicals. The arrow in the formula is a conventional representation of a semipolar bond. Examples of amine oxides suitable for use in this invention include dimethyldodecyl-amine oxide, oleyl-di(2-hydroxyethyl) amine oxide, dimethyloctylamine oxide, dimethyloctylamine oxide, dimethyltetradecylamine oxide, 3,6,9 trioxaheptadecyldiethylamine oxide, di(2-hydroxyethyl)-tetradecylamine oxide, 2-dodecoxyethyl-dimethylamine oxide, 3-dodecoxy-2-hydroxy-propyldi(3-hydroxy-propyl) amine oxide, dimethylhexadecylamine oxide.

5. Long chain tertiary phosphine oxides corresponding to the following general formula:

RR′R″P→O

wherein R contains an alkyl, alkenyl or monohydroxyalkyl radical ranging from 8 to 20 carbon atoms in chain length, from 0 to about 10 ethylene oxide moieties and from 0 to 1 glyceryl moiety and R′ and R″ are each alkyl or mono-hydroxyalkyl groups containing from 1 to 3 carbon atoms. The arrow in the formula is a conventional representation of a semipolar bond. Examples of suitable phosphine oxides are: dodecyldimethylphosphine oxide, tetradecylmethylethyl-phosphine oxide, 3,6,9-trioxaoctadecyldimethyl-phosphine oxide, cetyldimethylphosphine oxide, 3-dodecoxy-2-hydroxy-propyldi(2-hydroxyethyl) phosphine oxide stearyl-dimethyl-phosphine oxide, cetylethyl propylphosphine oxide, oleyl-diethyl phosphine oxide, dodecyldiethylphosphine oxide, tetradecyldiethyl-phosphine oxide, dodecyldipropylphosphine oxide, dodecyldi(hydroxymethyl)phosphine oxide, do-decyldi(2-hydroxy-ethyl)phosphine oxide, tetradecyl-methyl-2-droxypropylphosphine oxide, oleyldimethyl-phosphine oxide, 2-hydroxydodecyldimethylphosphine oxide.

6. Long chain dialkyl sulfoxides containing one short chain alkyl or hydroxy alkyl radical of 1 to about 3 carbon atoms (usually methyl) and one long hydrophobic chain which contain alkyl, alkenyl, hydroxy alkyl, or keto alkyl radicals containing from about 8 to about 20 carbon atoms, from 0 to about 10 ethylene oxide moieties and from 0 to 1 glyceryl moiety. Examples include: octadecyl methyl sulfoxide, 2-ketotridecyl methyl sulfoxide, 3,6,9-trioxaoctadecyl 2-hydroxyethyl sulfoxide, dodecyl methyl sulfoxide, oleyl 3-hydroxypropyl sulfoxide, tetradecyl methyl sulfoxide, 3 methoxytridecylmethyl sulfoxide, 3-hydroxytridecyl methyl sulfoxide, 3-hydroxy-4-dodecoxybutyl methyl sulfoxide.

7. Alkylated polyglycosides include wherein the alkyl group is from about 8 to 20 carbon atoms, preferably about 10 to about 18 carbon atoms and the degree of polymerization of the glycoside is form about 1 to about 3, preferably about 1.3 to about 2.0.

The quantity of surfactant employed in the cleansing composition is any cleansing amount. This can be a minimum of at least about 1, 2, 3 or 5 wt % of surfactant or mixture of surfactants. The maximum amount is not unduly critical and is at least partially dependent on the physical nature of the composition, solids having far more surfactant(s), to a maximum of about 85 to about 90 wt % of the solid composition than liquid. For liquid or gel compositions it is generally not uncommon to have a maximum of about 15, 20, 25, 30 or 35 wt % of the composition as surfactant.

The amount of antioxidant is present in any quantity, which is effective to neutralize at least a portion of a free radical bearing entity. Quantities of antioxidants in the compositions of the invention, particularly the cleansing compositions, are a minimum of about 0.03, about 0.05, or about 0.1 wt % of the composition. Generally, quantities of antioxidant need not to go above about 1 or about 0.5 wt % of the composition.

The amount of system, which is color sensitive to a free radical bearing entity, is generally, based on manufacturer's recommended level but can be used at a minimum of 50% of recommended levels.

Below are comparative examples and examples of the invention. The examples are meant to illustrate the broad nature of the invention.

### COMPARATIVE EXAMPLE 1

Cumene hydroperoxide (CHP) at 16-nano mole is mixed with a glass rod with 190 μl of an enzyme solution having ascorbic oxidase and lipo protein lipase (Reagent 1, LPO assay kit by Kamiya Biomedical Company, Seattle, Wash.). This is followed by 380 μl of the color substrate MCDP and hemoglobin (Reagent 2, Kamiya Biomedical Company). A blue color developed in about 10-30 seconds.

This clearly demonstrates the principle of the test wherein in the presence of hemoglobin, lipid hydroperoxide is reduced to hydroxyl derivatives (lipid alcohols), while at the same time, methylene blue derivatives (MCDP) is oxidatively cleaved to form methylene blue in an equimolar reaction to show the correspondence to lipid peroxides.

### COMPARATIVE EXAMPLE 2

Following the procedure of Comparative Example 1, prior to contacting with Reagent 1 and 2, the CHP on the watch glass is contacted with 100 mg of a surfactant containing body wash. No change in time of color formation or intensity of color is observed. This experiment demonstrated two effects. Firstly because there was no antioxidant in the cleansing formulation, no effect was observed. Secondly, the cleansing composition itself did not affect any significant change in the color formation and intensity.

### EXAMPLE 1

Following the procedures of comparative Example 1 and 2, the same body wash in Comparative Example 2 but containing 0.15 wt % of Vitamin E is added to the watch glass. Formation and intensity of the color is substantially inhibited. These results show that Vitamin E in a surfactant containing cleanser composition can neutralize free radicals as shown by the reduced interaction of the lessened quantity of free radical bearing entity with the visual detection system. It is surprising that this occurs with an ordinary cleansing composition as opposed to a laboratory setting with only free radical bearing entity and antioxidant.

A comparative test with Vitamin E acetate instead of Vitamin E does not inhibit formation and intensity of color.

### EXAMPLE 2

### Setting up Standard Curve and Measuring Unknown Reagents

Cumene hydroperoxide (80% soln)

Stock₁=14.5 μl in 1 ml ethanol=80 mM

$$\begin{matrix}{Stock}_{2} = 20 μl of 80 mM ( Stock ) + 1980 μl of ethyl acetate \\ = 800 μM \\ = 0.8 mM\end{matrix}$$

Standards:

1. 100 μl * 0.8 μmoles/ml=400 μl * X

X=(100X0.8)/400

X=0.2 μmoles/ml or 4 nmoles/20 μl.

2. Make 2-fold dilutions in 50 μl of ethyl acetate for 4, 2, 1, 0.5 and 0.25 nmoles/20 μl

3. Take 37.5 μl from 0.2 μmoles/ml and dilute with 12.5 μl ethyl acetate to make a 3 nmoles/20 μl sample. Prepare samples for assay as described below:

Assay Procedure:

1. Add 20 μl standards cumene hydroperoxide to a microfuge tube (in duplicate)

2. Add 250 μl reagent #1, (enzymes) incubate 5 min at 30° C.

3. Add 500 μl reagent #2, (color substance and hemoglobin) incubate 15-30 min at 30° C.

4. Centrifuge in a microfuge for 6′ at 14,000 rpm, remove supernatant fluid and transfer to a plastic cuvette for spectrometric assay at 672 nm

TABLE I
Standard CHP Solutions

| | Concentration | |
|---|---|---|
| Sample | μmoles/ml | Quantity nmoles/20 μl |
| 1 | 0.20 | 4.0 |
| 2 | 0.15 | 3.0 |
| 3 | 0.10 | 2.Ot |
| 4 | 0.05 | 1.0 |
| 5 | 0.025 | 0.50 |
| 6 | 0.0125 | 0.25 |
| 7 | 0 | Blank |

te.g.: 0.1 μmoles/ml = 100 nmoles/ml = 1 nmoles/10 μl, 2 nmoles/20 μl

An analysis showing actual absorbance readings is shown below in Table II:

TABLE II

| Cumene Hydroperoxide | Absorbency (n = 2) |
|---|---|
| (nmole/20 μl) | (mean value) |
| 0.25 | 0.02 |
| 0.5 | 0.034 |
| 1.0 | 0.08 |
| 2.0 | 0.25 |
| 3.0 | 0.39 |
| 4.0 | 0.53 |

1. Pipette 300 μl PO Vit E body wash into three micro centrifuge tubes. Also pipette 300 μl of PO body wash vehicle into three different centrifuge tubes, repeat the same procedure using liquid Dial® and Dove® Nutrium.

2. Add 10 μl of 0.8 mM cumene hydroperoxide to each of the tubes and mix well.

3. Add 200 μl of solution Reagent R1 (enzymes), mix well and let stand for 2-3 minutes.

4. Add 400 μl of solution Reagent II (color substance and hemoglobin) and mix well.

5. Label three different cuvettes for each of the samples and transfer the solution while taking precautions to minimize exposure to light.

6. Read Absorbency at Wavelength of 672 nm of all the three samples against Vit E body wash using Spectrophotometer and record the data.

TABLE III
Absorbance Reading of Certain Compositions after
Correlation with Standard Curve

| | Absorbance |
|---|---|
| Product | Reading |
| Vitamin E Body | 0.00 |
| Wash | |
| Vehicle for | 0.23 |
| Vitamin E Body | |
| Wash | |
| Dish Liquid | 0.38 |
| Hand Soap | |
| Dove Nutrium | 0.39 |
| Body Wash | |

This data shows that there is substantially more neutralization of free radical activity using a Vitamin E containing cleaning composition than standard marketed products.

What is claimed is:

1. A method for demonstrating the effectiveness of an antioxidant containing composition in neutralizing a free radical bearing entity which comprises:
(a) contacting said composition with a free radical bearing entity for a period of time to neutralize at least a portion of the free radical bearing entity thereby forming a second composition which has at least some neutralized free radical bearing entity,
(b) contacting at least a portion of the second composition with a system which is color sensitive to a free radical bearing entity for a sufficient time for any color change to develop, and
(c) evaluating the evolved change in color.

2. The method in accordance with claim 1, wherein the antioxidant containing composition has a skin cleansing amount of a least one surfactant or mixture of surfactants.

3. The method in accordance with claim 2 wherein the composition is a liquid or gel.

4. The method in accordance with claim 2 wherein the composition is a solid.

5. The method in accordance with claim 3 wherein an anionic surfactant is present in the composition.

6. The method in accordance with claim 2 wherein the antioxidant is a vitamin.

7. The method in accordance with claim 6 wherein the antioxidant is Vitamin E.

8. The method in accordance with claim 2 wherein the free radical bearing entity is produced by exposure of skin to environmental effects.

9. The method in accordance with claim 2 wherein the system of (b) is 10-N-methylcarbamoyl-3, 7-dimethylamino-10 H-phenothiazine (MCDP).

10. The method in accordance with claim 3 wherein the system of (b) is 10-N-methylcarbamoyl-3, 7-dimethylamino-10 H-phenothiazine (MCDP).

11. The method in accordance with claim 5 wherein the system of (b) is 10-N-methylcarbamoyl-3, 7-dimethylamino-10 H-phenothiazine (MCDP).

12. The method in accordance with claim 2 wherein a standard curve is prepared from a series of free radical containing compositions containing known levels of free radicals.

13. The method in accordance with claim 12, wherein an antioxidant containing composition having an unknown level of antioxidant is evaluated with the use of the standard curve.

14. The method in accordance with claim 1 wherein the evolved change in color is evaluated with the human eye.

15. The method in accordance with claim 2 wherein the evolved change in color is evaluated with instrumentation sensitive to color change.

16. The method in accordance with claim 1 wherein the evolved change in color occurs in less than 60 seconds from the initial contacting of the second composition with the system of (b).

17. The method in accordance with claim 2 wherein the evolved change in color occurs in less than 30 seconds from the initial contacting of the second composition with the system of (b).
